(19) United States
(12) Patent Application Publication
(10) Pub. No.: US 2026/0229980 A1
(43) Pub. Date: Aug. 6, 2026

(54) POWER CONVERSION DEVICE, POWER CONVERSION METHOD, AND NON-TRANSITORY COMPUTER-READABLE STORAGE MEDIUM STORING POWER CONVERSION PROGRAM

(71) Applicant: Mitsubishi Electric Corporation, Chiyoda-ku, Tokyo (JP)

(72) Inventors: Rutvikanandan MANOHAR, Chiyoda-ku, Tokyo (JP); Sadayuki INOUE, Chiyoda-ku, Tokyo (JP); Koki MATSUMOTO, Chiyoda-ku, Tokyo (JP); Yu KAWAI, Chiyoda-ku, Tokyo (JP); Keishi MATSUDA, Chiyoda-ku, Tokyo (JP); Shuto ISHIYAMA, Chiyoda-ku, Tokyo (JP)

(73) Assignee: Mitsubishi Electric Corporation, Chiyoda-ku, Tokyo (JP)

(21) Appl. No.: 19/153,001

(22) PCT Filed: Mar. 3, 2023
(86) PCT No.: PCT/JP2023/008009

§ 371 Date: Aug. 1, 2025

(51) Int. Cl. H02M 1/00; H02J 3/38; H02J 3/40; H02J 3/46; H02J 103/30

(52) U.S. Cl. CPC H02M 1/0009; H02J 3/381; H02J 3/40; H02J 3/46; H02J 2103/30

(57) ABSTRACT

A power conversion device according to the present disclosure includes: an inverter configured to convert direct current power of a distributed power source into alternating current power; a control parameter management unit configured to manage a control parameter of the inverter; a detection unit configured to detect output power of the inverter and to output the output power as a detected value; and an inverter control unit configured to generate a voltage command value to be used to control the inverter, in which the inverter control unit changes a drooping characteristic based on the detected value and a power command value and generates the voltage command value based on the changed drooping characteristic.

### TECHNICAL FIELD

The present disclosure relates to a power conversion deice, a power conversion method, and a power conversion program.

### BACKGROUND ART

Patent Document 1 discloses an inverter control device for converting direct current power generated by using renewable energy or the like into alternating current power. The Inverter control device stably operates a plurality of inverters having different ratios of output power to rated output power. Such an inverter control device is also used, for example, to connect a distributed power source to a power system, In the distributed power source in the related art, the output power is determined based on a power command value from a device that manages a power system.

### CITATION LIST

### Patent Documents

Patent Document 1: Japanese Unexamined Patent Application, First Publication No. 2020-198705

### SUMMARY OF INVENTION

### Problem to be Solved by the Invention

The output power of the distributed power source is generally determined based on a drooping characteristic. Here, in a case where the out put power is determined based on the power con and value and the drooping characteristic, the output power of the distributed power source may exceed an upper limit value (for example, a rated capacity) thereof when load fluctuation occurs in the power system. As a result, the operation of the distributed power source may be stopped.

In view of the above circumstances, an object of the present disclosure is to provide a power conversion device, a power conversion method, and a power conversion program that, when determining output power of a distributed power source using a drooping characteristic, can prevent the output power from exceeding an upper limit value thereof.

### Means to Solve the Problem

An aspect according to the present disclosure is a power conversion device for supplying alternating current power to a power system a voltage source based on a power command value generated by a power management device, the power conversion device including: an inverter configured to convert direct current power of a distributed power source into alternating current power; a control parameter management unit configured to manage a control parameter of the inverter; a detection unit configured to detect output power of the inverter and to output the output power a detected value; and an inverter control unit configured to generate a voltage command value based on the detected value, the power command value, and the control parameter, the voltage command value being used to control the inverter, in which the control parameter is related to a drooping characteristic that is a correlation between the output power of the inverter and a frequency, and the inverter control unit changes the drooping characteristic based on the detected value and the power command value and generates the voltage command value based on the changed drooping characteristic.

An aspect of a po er conversion method according to the present disclosure includes: detecting output power of an inverter as a detected value; changing a drooping characteristic that is a correlation between the output power of the inverter and a frequency, based on a power command value generated by a power management device and the detected value; generating a voltage command value based on the changed drooping characteristic; and converting direct current power of a distributed power source into alternating current power based on the voltage command value.

An aspect of a power conversion program according to the present disclosure causing a computer to execute: changing a drooping characteristic that is a correlation between output power of an inverter and a frequency, based on a power command value generated by a power management device a detected value of the output power of the inverter; generating a voltage command value based on the changed drooping characteristic; and converting direct current power of a distributed power source into alternating current power based on the voltage command value.

### Effects of the Invention

According to the present disclosure, when determining output power of a distributed power source using a drooping characteristic, it is possible to prevent the output power from exceeding an upper limit value thereof.

### BRIEF DESCRIPTION OF DRAWINGS

FIG. 1 A diagram showing the configuration of a power system management system including a power conversion vice according to an embodiment.

FIG. 2 A block diagram showing an example of a load of FIG. 1.

FIG. 3 A block diagram showing an example configuration of a power management device of FIG. 1.

FIG. 4 A block diagram showing an example configuration of a first control parameter management unit of FIG. 1.

FIG. 5 A block diagram showing an example configuration of a first distributed power source and a first inverter of FIG. 1.

FIG. 6 A block diagram showing an example configuration of a first detection unit of FIG. 1.

FIG. 7 A block diagram showing an example configuration of a first inverter control unit of FIG. 1.

FIG. 8 A block diagram showing an example configuration of a VSG control unit of FIG. 7.

FIG. 9 A block diagram showing an example configuration of a voltage control unit of FIG. 7.

FIG. 10 A block diagram showing an example configuration of a Pref control unit of FIG. 7.

FIG. 11 A block diagram showing an example configuration of a converter control unit of FIG. 5.

FIG. 12 A diagram showing a change in a drooping characteristic when a load increases.

FIG. 13 A diagram showing a change in the drooping characteristic when the load decreases.

FIG. 14 A diagram showing an example of an operation of the power conversion device when the load increases and then decreases.

FIG. 15 A diagram showing an example of an operation of the power conversion device when the load decreases and then increases.

FIG. 16 A flowchart showing a self-correction flow performed by the power conversion device.

FIG. 17 A flowchart showing a calculation flow of a control deviation in FIG. 16.

FIG. 18 A first example of a drooping characteristic in droop control.

FIG. 19 A second example of the drooping characteristic in droop control.

FIG. 20 A third example of the drooping characteristic in droop control.

FIG. 21 A fourth example of the drooping characteristic in droop control.

FIG. 22 A flowchart showing another self-correction flow performed by the power conversion device.

FIG. 23 A flowchart showing a calculation flow of Pref control in FIG. 22.

FIG. 24 A flowchart showing end determination of Pref control in FIG. 23.

### DESCRIPTION OF EMBODIMENTS

Hereinafter, embodiments of the present disclosure will be described with reference to the drawings. The scope of the present disclosure is not limited to the following embodiments and can be arbitrarily changed within the scope of technical ideas of the present disclosure.

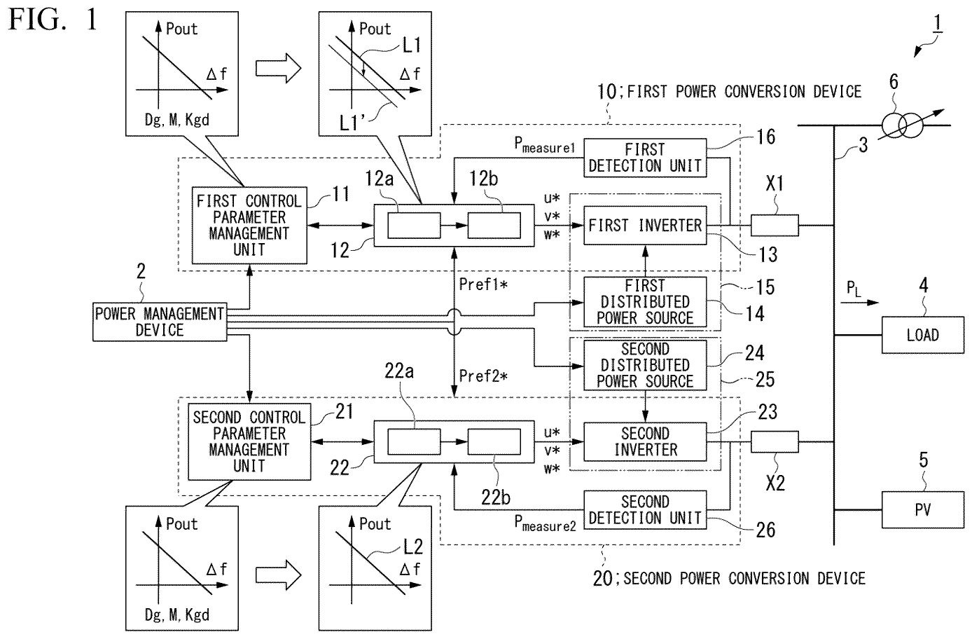

FIG. 1 is a diagram showing the configuration of a power system management system including a power conversion device in the present embodiment. A power system management system 1 manages, for example, an autonomous power system in a microgrid. In the autonomous power system, for example, as shown in FIG. 1, a distribution line 3 connected to a distribution voltage transformer 6 is provided. A first distributed power source 14, a second distributed power source 24, a load 4, and a photovoltaic power generation facility 5 (abbreviated as PV in the drawings) are connected to the distribution line 3. The microgrid is applied to, for example, a smart city, a building, a factory, an uninhabited island, or the like. However, application examples of the power system management system I are not limited thereto.

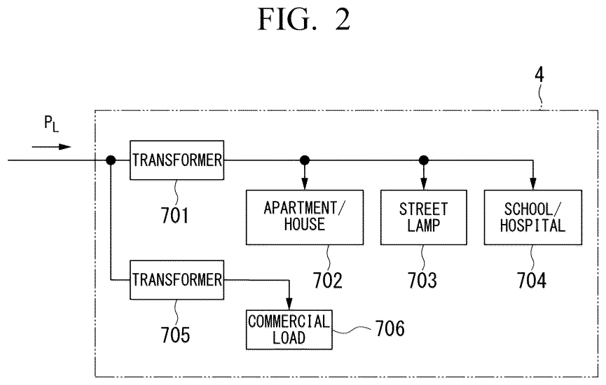

A power generation facility (a wind power generator, a hydroelectric power generator, or the like) using natural energy other than the photovoltaic power generation facility 5 may be connected to the power system management system 1. In addition, a thermal power plant or the like may be connected to the power syst management system 1. The load 4 shown in FIG. 1 is a facility that consume As shown in FIG. 2, the load 4 includes, for example, an apartment/house 702, a street lamp 703, a school/hospital 704, a commercial load 706, and the like. An alternating current is supplied to the loads 702 to 704 through a transformer 701. An alternating current is supplied to the commercial load 706 through a transformer 705.

As shown in FIG. 1, the power system management system I includes a power management device 2, a first power conversion device 10, a second power conversion device 20, a first distributed power source 14, and a second distributed power source 24. The first distributed power source 14 and the second distributed power source 24 are, for example, storage batteries. The power conversion devices 10 and 20 convert the direct current power of the distributed power sources 14 and 24 into alternating current power in accordance with the power demand in the load 4 and supply the alternating current power to the distribution line 3. In addition, the pow er conversion devices 10 and 20 may charge the distributed power sources 14 and 24 using surplus power in a case where the power consumption in the load 4 is small.

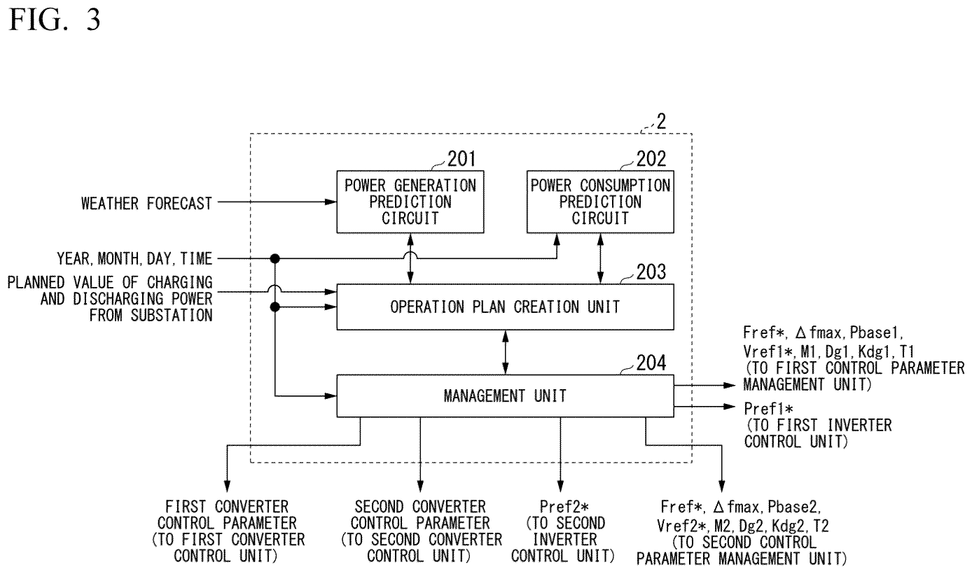

The power management device 2 is, for example, a community energy management system (CEMS), an aria energy management system (AEMS), a building and energy management system (BEMS), or the like. The power management device 2 manages the supply and demand of power in the autonomous power system. FIG. 3 shows an example configuration of the power management device 2. The power management device 2 includes, for example, a r generation prediction circuit 201, a power consumption prediction circuit 202, an operation plan creation unit 203, and a management unit 204, The power generation prediction circuit 201 predicts the power to be generated by the photovoltaic power generation facility 5 and generates power generation information that is a prediction result thereof. The power generation prediction circuit 201 may predict the power to be generated based on a weather forecast.

The power consumption prediction circuit 202 predicts the power to be consumed by the load 4 and generates power consumption information that is a prediction result thereof. The power consumption information generated by the power consumption prediction circuit 202 includes information such as date (year, month, and day) and time. The operation plan creation unit 203 creates operation plans of the first power conversion device 10 and the second power conversion device 20, based on the power generation information output from the power generation prediction circuit 201 and the power consumption information output from the power consumption prediction circuit 202. The operation plan creation unit 203 is also notified of the planned value of the charging and discharging power from a substation. The planned value notified from the substation is information related to the charging and discharging power, for example, for 30 minutes at a 30-minute cycle,

The management unit 204 manages creation of operation plans of the distributed power sources 14 and 24 connected to the distribution line 3. The management unit 204 stores power command values Pref1* and Pref2*, a frequency command value Fref*, control parameters, and the like generated by the operation plan creation unit 203. The management unit 204 outputs a first power command value Pref1* and a second power command value Pref2* to a first inverter control unit 12 and a second inverter control unit 22, which will be described later. The management unit 204 outputs the control parameters to each of a first control parameter management unit 11 and a second control parameter management unit 21, which will be described later. The control parameter is used for virtual synchronous generator (VSG) control, which will be described in detail later. In FIG. 3, the control parameters to be output to the first control parameter management unit 11 and the second control parameter management unit 21 are denoted by M1, M2, and the like, respectively In the present embodiment, a case where the VSG control is applied to the first inverter control unit 12 and the second inverter control unit 22 is described, but the present disclosure is not limited thereto. It is needless to say that the same effect ca be obtained by providing the inverter that operates as a voltage source with a drooping characteristic (output power-output alternating current system voltage frequency characteristic).

As shown in FIG. 1, the first power conversion device 10 includes the first control parameter management unit 11, the first inverter control unit 12, a first inverter 13, and a first detection unit 16. The second power conversion device 20 includes the second control parameter management unit 21, the second inverter control unit 22, a second inverter 23, and a second detection unit 26, The first inverter control unit 12 includes a first Pref control unit 12a and a first voltage/frequency control unit 12b. The second inverter control unit 22 includes a second Pref control unit 22a and a second voltage/frequency control unit 22b.

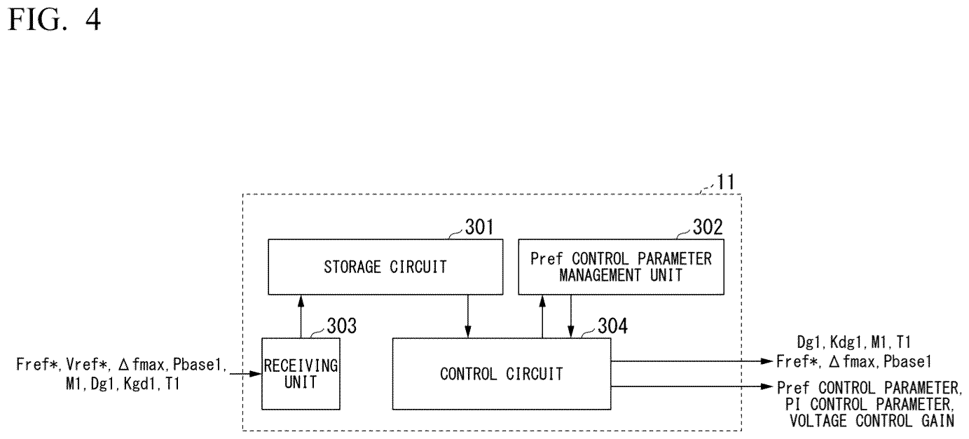

FIG. 4 shows an example configuration of the first control parameter management unit 11. Although an example configuration of the second control parameter management unit 21 is omitted in the drawings, the second control parameter management unit 21 may have the same configuration as that of the first control parameter management unit 11. The other parts of the second power conversion device 20 may have the same configurations as those of the first power conversion device 10. As shown in FIG. 4, the first control parameter management unit 11 includes, for example, a storage circuit 301, a Pref control parameter management unit 302, a receiving unit 303, and a control circuit 304.

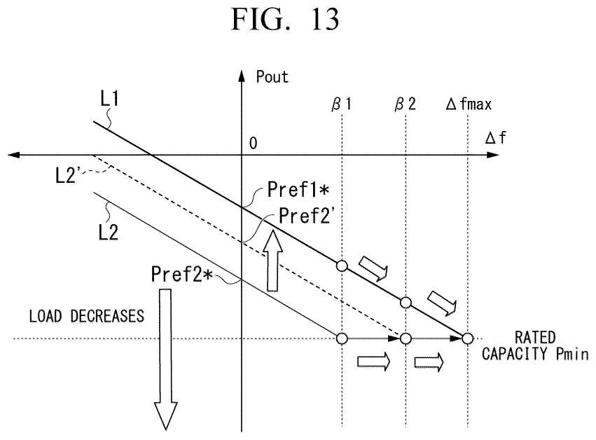

The receiving unit 303 receive various types of information output from the management unit 204 of the power management device 2. The various types of information include a frequency command value Fref*, an effective voltage Vref* of the alternating current system, a rated capacity Phase of the first distributed power source 14, Dag information, Δfmin, Δfmax, control parameters, and the like. The rated capacity Pbase1 is, for example, information related to a discharge-side rated capacity Pmax or a charge-side rated capacity Pmin, which will be described later. The flag information is, for example, a flag value Pref_flag, which will be described later. Δfmin and Δfmax will be described later (see FIGS. 12 and 13). The storage circuit 301 stores various types of information received by the receiving unit 303 and outputs the information to the control circuit 304, The control circuit 304 controls the operation of the first control parameter management unit 11. The Pref control parameter management unit 302 manages Pref*, a Pref control parameter, a PI control parameter, a voltage control gain, and the like notified from the power management device 2. The first control parameter management unit 11 communicates with the first inverter control unit 12 and outputs the various types of information described above to the first inverter control unit 12. It is needless to say that default values in the power conversion devices 10 and 20 may be used for the PI control parameter, the voltage control gain, and the like.

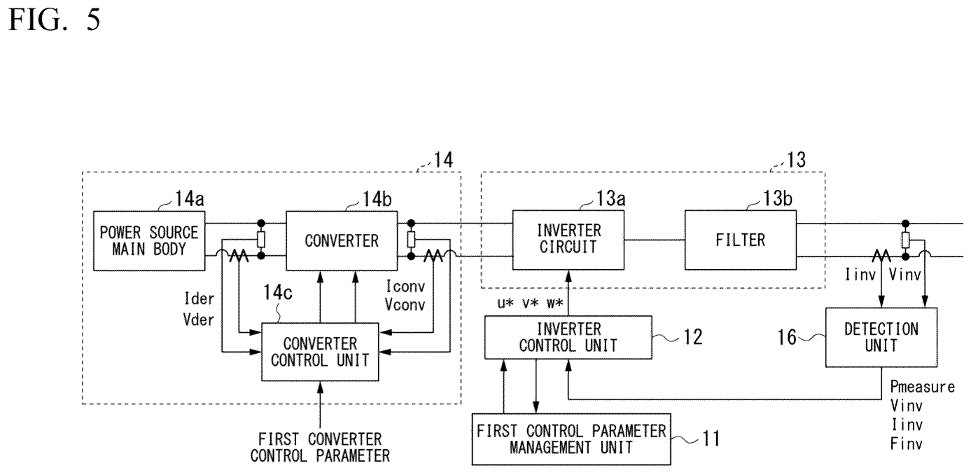

FIG. 5 shows an example configuration of the first distributed power source I and the first inverter 13. As shown in FIG. S, the first distributed power source 14 includes, for example, a power source main body 14a, a converter 14b, and a converter control unit 148. The power source main body 14a is, for example, a main body portion of a storage battery. A first converter control parameter output from the management unit 204 of the power management device 2, a current Ider and a voltage Vder between the converter 14b and the power source main body 14a, a current Iconv and a voltage Vconv between the converter 14b and the first inverter 13, and the like are input to the converter control unit 14c. The converter control unit 14e controls the converter 14b based on these inputs.

The converter 14b converts the voltage of the direct current of the power source main body 14a and outputs the converted voltage to the first inverter 13, under the control of the converter control unit 14c. The first inverter 13 includes, for example, an inverter circuit 13a and a filter 13b. The inverter circuit 13a converts direct current into alternating current based on target voltages u*, v* and w* output from the inverter control unit 12. The filter 13b adjusts the voltage of the alternating current output from the inverter circuit 13a. The first detection unit 16 detects a detected value Pmeasure, a voltage Vinv, a current Iinv, and a frequency Finv of the output power of the first inverter 13 and feeds back them to the first inverter control unit 12.

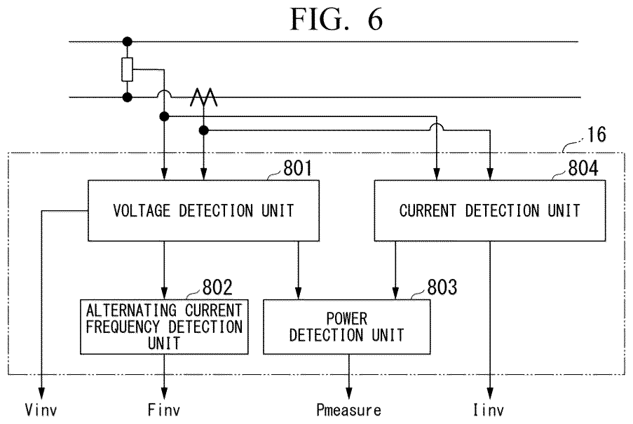

FIG. 6 shows an example configuration of the first detection unit 16. As shown in FIG. 6, the first detection unit 16 includes a voltage detection unit 801, an alternating current frequency detection unit 802, a power detection unit 803, and a current detection unit 804. The voltage detection unit 801 detects the voltage Vinv. The alternating current frequency detection unit 802 detects the frequency Fint. The current detection. unit 804 detects the current Iinv, The power detection unit 803 detects power based on the detection results of the voltage detection unit 801 and the current detection unit 804 and outputs the power as the detected value Pmeasure.

The first distributed power source 14 and the first inverter 13 are collectively referred to as a “first inverter power source 15”. The second distributed power source 24 and the second inverter 23 are collectively referred to as a “second inverter power source 25”. The inverter power sources 15 and 25 may be virtual synchronous. generators (VSGs). In other words, the power conversion devices 10 and 20 may perform the VSG control. By performing the VSG control, it is possible to impart inertia to the alternating current power generated by using the dis r sources 14 and 24 and to enhance stability against load fluctuation. However, the power conversion devices 10 and 20 may not perform the VSO control. In addition, the power system management system 1 may include three or more distributed pe sources. In the present embodiment, a case where the VSG control is applied is described, but the present disclosure is not limited thereto. It is needless to say that the same effect can be obtained by providing the inverter that operates as a voltage source with a drooping characteristic (output power-output alternating current system voltage frequency characteristic),

The first power com version device 10 and the second power conversion device 20 may perform an equal control to each other. Hereinafter, the control mainly performed in the first power conversion device 10 will be described by representing the two power conversion devices 10 and 20. However, contents of the control performed by the first power conversion device 10 and the second power conversion device 20 may be different.

Terms used in the present specification are defined as follows.
First power command value Pref1*: A command value for the output power to the first distributed power source 14, which is determined by the power management device 2.
Second power command value Pref2*: A command value for the output power to the second distributed power source 24, which is determined by the power management device 2.
First target output Pref1: Output power that is a target of the first inverter power source 15, which is determined by the first Pref control unit 12a.
Second target output Pref2: Output power that is a target of the second inverter power source 25, which is determined by the second Pref control unit 22a.
First change command value Pref1′: A value obtained after the first power con version device 10 offsets the first power command value Pref1*.
Second change command value Pref2: A value obtained after the second power conversion device 20 offsets the second power command value Pref2*,
First output power Pout1: Output power of the first inverter power source 15.
Second output power Pout2: Output power of the second inverter power source 25.
First detected value Pmeasure1: A value of the first output power Pout1 detected by the first detection unit 16.
Second detected value Pmeasure2; A value of the second output power Pout2 detected by the second detection unit 26.

In the following descriptions, the first power command value Pref1* and the second power command value Pref2* may be described as a “power command value Pref” without distinction. Similarly, the first target output Pref1 and the second target output Pref2 may be described as “target output Pref”, the first change command value Pref1′ and the second change command value Pref2′ may be described as “change command value Pref”, the first output power Pout1 and the second output power Pout2 may be described as “output power Pout”, and the first detected value Pmeasure1 and the second detected value Pmeasure2 may be described as “detected value Pmeasure” without distinction,

The power management device 2 generates, for example, the first power command value Pref1* and the second power command value Pref2* based on a 14 prediction of the power demand in the load 4. The first power command value Pref1* is input to the first inverter control unit 12 from the power management device 2. The second power command value Pref2* is input to the second inverter control unit 22 front the power management device 2. The inverter control units 12 and 22 calculate the target output Pref based on the power command value Pref*.

Next, an outline of the VSG control will be described. The VSG control imitates the operation of a synchronous generator as follows, In a case where the load fluctuation occurs, the synchronous genera er increases or decreases rotational energy of a rotating body in the synchronous generator in accordance with an oscillation equation. As a result, a balance is maintained between the amount of power supplied by the synchronous generator and the power consumed by the load. For example, in a case where the load increases, the rotational energy is output from the rotating body in the synchronous generator, and the rotation speed (frequency of the alternating current system) of the rotating body decreases. In addition, in a case where the load decreases, the rotating body in the synchronous generator takes in the surplus energy, and the rotation speed (frequency of the alternating current system) of the rotating body increases.

In general, the synchronous generator is provided with a governor function. It is assumed that the amount of energy supplied to the synchronous generator is large in a case where the rotation speed (frequency) of the rotating body increases. Therefore, in he governor function, the amount of energy supplied to the synchronous generator is decreased in a case where the rotation speed of the rotating body increases. In addition, the amount of energy supplied to the synchronous generator is increased in a case where the rotation speed (frequency) of the rotating body decreases.

In the VSG control, the operation of the synchronous as described above is imitated. Specifically, the first control parameter management unit. 11 shown in FIG. 1 manages a control parameter for the first inverter power source 15 to perform the VSG control. The term “control parameter” is, for example, a damping coefficient Dg, an inertia constant M, a governor gain Kdg, a governor time constant T, and the like. The damping coefficient Dg is a quantity that represents a damping force (brake) with respect to a change in frequency. The inertia constant M is an inertial force of the rotating body to be imitated in the VSG control. The governor gain Kdg is a proportional gain for imitating the governor function described above. The governor time constant T is a transmission delay in the governor function,

The oscillation equation in the rotating body of the synchronous generator is represented by “Tin−Tout=M×dω/dt+Dg×ω”. Even in the VSG control, the output power of the inverter power sources 15 and 25 is determined based on the same oscillation equation. In addition, Tin is a torque input to the rotating body, Tout is a torque output from the rotating body, and ω is an angular velocity of the rotating body, The governor function of the synchronous generator is generally represented by a first-order lag system model, such as “−1/Kgd×{1/(1+S×T)}”.

The control parameter managed by the control parameter it unit 11, the first power command value Pref1* output by the power mana device 2, and the first detected value Pmeasure1 detected by the first detection unit 16 are input to the Pref control unit 12a. The Pref control unit 12a calculates the target output Pref1 based on these input values and outputs the target output Pref1 to the voltage/control unit 12b. The voltage/frequency control unit 12b determines three-phase voltages u*, v*, and w* to satisfy the target output Pref1, u* is a target voltage related to a U phase, v* is a target voltage related to a V phase, and w* is a target voltage related to a W phase. The first inverter 13 converts the direct current power of the first distributed power source 14 into alternating current power based on the target voltages u*, v*, and w*. The alternating current power is supplied to the distribution line 3 through distribution equipment X1.

The control parameter managed by the control parameter management unit 21, the second power command value Pref2+output by the power management device 2, and the second detected value Pmeasure2 detected by the second detection unit 26 are input to the Pref control unit 22a. The Pref control unit 22a calculates the target output Pref2 based on these input values and outputs the target output Pref2 to the voltage/frequency control unit 22b. The voltage/frequency control unit 22b determines three-phase target voltages of, y, and w* to satisfy the target output Pref2. The second inverter 23 converts the direct current power of the second distributed power source 24 into alternating current power based on the target voltages u*, v* and w*. The alternating current power is supplied to the distribution line 3 through distribution equipment X2.

The first detection unit 16 detects power output by the first inverter power source 15 and feeds back the power to the first inverter control unit 12 as the first detected value Pmeasure1. The second detection unit 26 detects power output by the second inverter power source 25 and feeds back the power to the second inverter control unit 22 as the second detected value Pmeasure2. The inverter control units 12 and 22 perform feedback control using the detected value Pmeasure such that the detected value Pmeasure approaches the target output Pref.

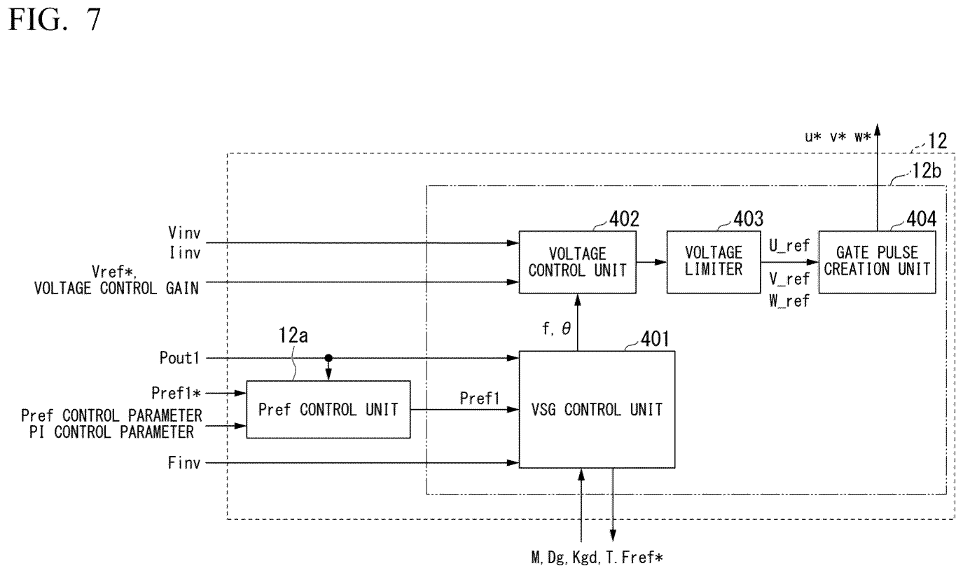

FIG. 7 shows an example configuration of the first inverter control unit 12. As shown in FIG. 7, the voltage/frequency control unit 12b of the first inverter control unit 12 includes a VSG control unit 401, a voltage control unit 402, a voltage limiter 403, and a gate pulse creation unit 404. The VSG control unit 401 performs VSG control based on the control parameter, the target output Pref1, and the like. The VSG control unit 401 outputs, to the voltage control unit 402, a voltage frequency f and phase information θ, which are the results of the VSG control

In addition to f and θ, the effective voltage Vref* of the alternating current. system, the voltage control gain, and the voltage Viny and the frequency Finv from the first detection unit 16 are input to the voltage control unit 402. Based on the various types of information, the voltage control unit 402 generates voltage waveforms of three phases (U phase, V phase, and W phase). The generated volta waveforms are input to the voltage limiter 403. The voltage limiter 403 performs predetermined processing on the input voltage waveforms to generate three-phase reference waveforms U_ref, V_ref. and W_ref for performing PWM modulation. The gate pulse creation unit 404 compares each of the reference waveforms U_ref, V_ref, and W_ref with a triangular wave and generates a gate pulse. Based on this gate pulse, the three-phase voltage to be output from the inverter power source 15 is determined. That is, in the present embodiment, the gate pulse corresponds the target voltages o*, v*, and w*.

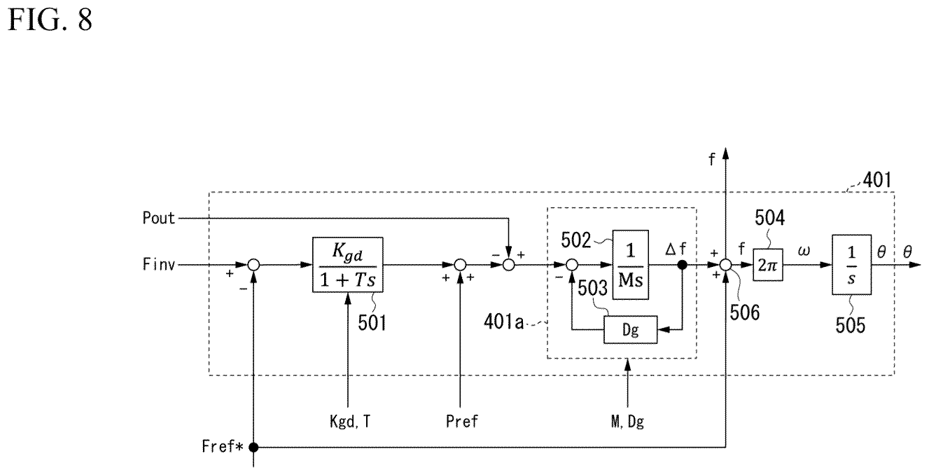

FIG. 8 shows an example configuration of the VSG control unit 401. The VSG control unit 401 includes a governor circuit 501, a first integrator 502, a first multiplier 503, a second multiplier 504, a second integrator 505, and an adder 506, The first integrator 502 and the first multiplier 503 are parts of a calculation unit 401a included in the VSG control unit 401, A difference between the frequency Fins detected by the first detection unit 16 and the frequency command value Fref* is input to the governor circuit 501. Based on the difference (Finv−Fref*), the governor circuit 501 calculates an offset value to be added to the target output Pref.

A result obtained by subtracting the target output Pref and the offset value from the output power Pout is input to the calculation unit 401a. A result obtained by subtracting the output of the first multiplier 503 from the input is input to the first integrator 502. The first integrator 502 generates a voltage frequency deviation Δf by multiplying the input value by 1/M and integrating the value. The first multiplier 503 multiplies the output of the first integrator 502 by the damping coefficient Dg. The adder 506 adds the frequency command value Fref* to the voltage frequency deviation Δf, which is generated by the first integrator 502, to calculate the voltage frequency f.

The second multiplier 504 multiplies the voltage frequency f by 2π to obtain the angular frequency ω. The second integrator 505 integrates the angular frequency wo to calculate the phase information θ. The voltage frequency f and the phase information θ obtained in this manner are input to the voltage control unit 402 as shown in FIG. 7.

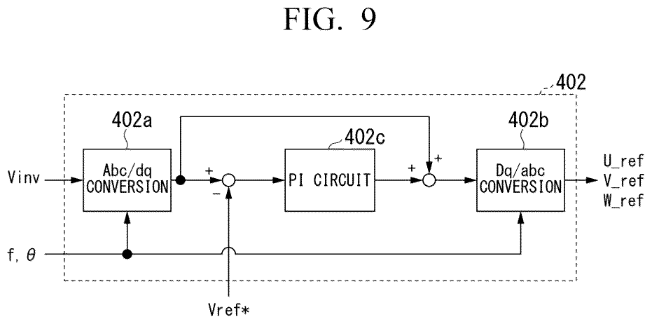

FIG. 9 shows an example configuration of the voltage control unit 402. The voltage control unit 402 includes a first conversion unit 402a that performs Abc/dq conversion, a second conversion unit 402b that performs Dq/abc conversion, and a PI circuit 402c. The first conversion unit 402a converts the voltage Viny obtained from the first detection unit 16 from values of three axes (a axis, b axis, and c axis) to values of two axes (d axis and q axis). The first conversion unit 402a uses the voltage frequency f and the phase information θ output from the VSG control unit 401 in this conversion.

A result obtained by subtracting the effective voltage Vref* from the output of the first conversion unit 402a is input to the PI circuit 402e. The PI circuit 402c performs PI control on this input. The second conversion unit 402b performs conversion from two axes to three axes on the sum of the output from the first conversion unit 402a and the output from the PI circuit 402e. In this conversion, the second conversion unit 402b uses the voltage frequency f and the phase information θ output from the VSG control unit 401, The output from the second conversion unit 402b serves as the basis for the reference waveforms U_ref, V_ref, and W_ref described above,

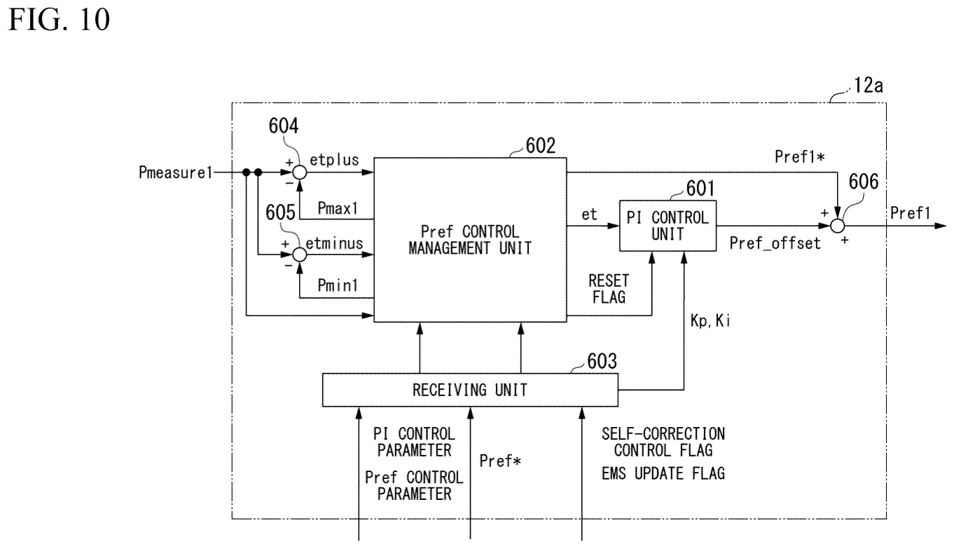

FIG. 10 shows an example configuration of the first Pref control unit 12a. The first Pref control unit 12a includes a PI control unit 601, a Pref control management unit 602, a receiving unit 603, a positive-side subtraction unit 604, and a negative-side subtraction unit 605. The receiving unit 603 receives the power command value Pref1* output from the power management device 2, a self-correction control flag and an EMS update flag output from the first control parameter management unit II and outputs them to the Pref control management unit 602.

The self-correction control flag indicates whether or not as to perform the change in the drooping characteristic. The EMS update flag indicates whether or not the power command value Pref-notified from the power management device 2 has been updated. In a case where both the self-correction control flag and the EMS update flag are set, the change in the drooping characteristic is temporarily stopped, and the power conversion is performed using the notified power command value Pref* as it is, The phrase “the flag is set” means, for example, that the value of the self-correction control flag or the EMS update flag is set to 1.

Further, the receiving unit 603 receives the Pref control parameter and the PI control parameter output from the power management device 2. The receiving unit 603 outputs the PI control parameter to the PI control unit 601 and outputs the other information to the Pref control management unit 602, The PI control parameter includes, for example, a proportional control gain Kp and an integral control gain Ki.

The Pref control parameter includes, for example, Pmax, Pmin, Pmax_high_threshold, Pmax_low_threshold, Pmin_high_threshold, and Pmin_low_threshold (details will be described later).

The positive-side subtraction unit 604 subtracts Pmax, which is output by the Pref control management unit 602, from the detected value Pmeasure, which is output by the first detection unit 16, and outputs the subtraction result (etplus) to the Pref control management unit 602. Similarly, the negative-side subtraction unit 605 subtracts Pmin from the detected value Pmeasure and outputs the subtraction result (etminus) to the Pref control management unit 602.

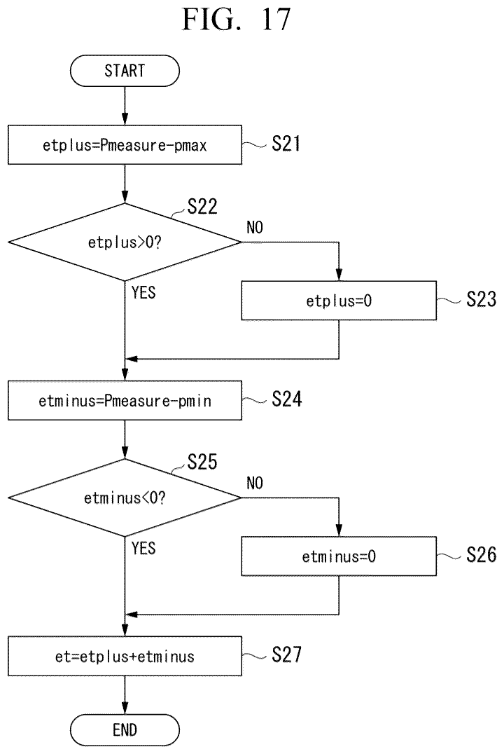

The Pref control management unit 602 generates a control deviation et based on the Pref control parameter, the self-correction control flag, the EMS update flag, and the power command value Pref* input from the receiving unit 603, the etplus output from the positive-side subtraction unit 604, and the etminus output from the negative-side 21 subtraction unit 605. The Pref control management unit 602 outputs the generated control deviation et to the PI control unit 601. A generation flow of the control deviation et will be described later (see FIG. 17). The Pref control management unit 602 generates a reset flag for resetting the integrator to be used for the integral control in the PI control unit 601 when the change in the drooping characteristic is temporarily stopped. The Pref control management unit 602 outputs the generated reset flag to the PI control unit 601,

The PI control unit 601 performs the PI control based on the PI control parameters (Kp, Ki) output by the receiving unit 603 such that the control deviation et is zero. A calculation result (pref_offset) of the PI control unit 601 is input to an addition unit 606. In addition, the power command value Pref1* is input to the addition unit 606 through the Pref control management unit 602. The addition unit 606 adds these values and generates the target output Pref1. The target output Pref1 is input to the VSG control unit 401 shown in FIG. 7, and is used as information in a case where the VSG control is performed.

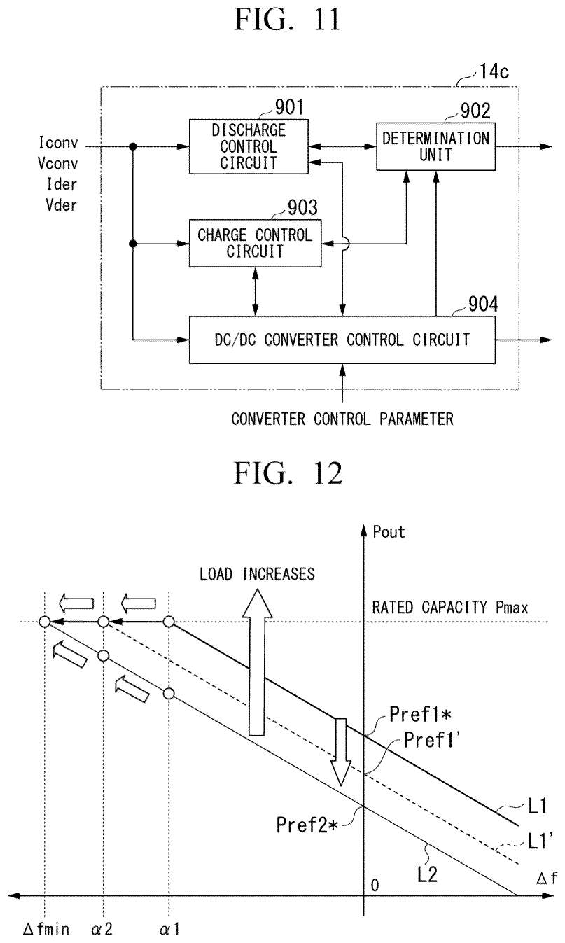

FIG. 11 shows an example configuration of the converter control unit 14c (see FIG. 5). As shown in FIG. 11, the converter control unit 14c includes a discharge control circuit 901, a determination unit 902, a charge control circuit 903, and a DC/DC converter control circuit 904. The discharge control circuit 901 generates a control command value of the converter 14b used in a case of performing discharge control of the first distributed power source 14. The charge control circuit 903 generates a control command value of the converter 14b used in a case of performing charging control of the first distributed power source 14. The DC/DC converter control circuit 904 outputs parameters, ta values, and the like to be used for control to the discharge control circuit 901 and the charge control circuit 903. The DC/DC converter control circuit 904 manages the charging power amount (SOC), the charging power (charging current), the discharging power (discharging current), and the like of the first distributed power source 14. The DC/DC converter control circuit 904 outputs a control signal for controlling the determination unit 902.

The determination unit 902 selectively outputs the output of either one of the discharge control circuit 901 or the charge control circuit 903 as the control command value of the converter 140 in accordance with the control signal from the DC/DC converter control circuit 904. Specifically, in a case where an instruction to charge the first distributed power source 14 is input, the determination unit 902 outputs the control command value generated by the charge control circuit 903. In a case where an instruction to discharge the first distributed power source 14 is input, the determination unit 902 outputs the control command value generated by the discharge control circuit 901.

Next, the drooping characteristics (drooping characteristics based on the VSG control of the present embodiment) of the power conversion devices 10 and 20 will be described with reference to FIGS. 12 and 13. The drooping characteristics are a correlation between the output power Pout of the inverter power sources 15 and 25 and the frequency. FIGS. 12 and 13 are specific examples of the drooping characteristics, and represent a relationship between the deviation Δf with respect to the frequency command value Fref* and the output power Pour. In FIGS. 12 and 13, a horizontal axis is the deviation Δf related to the frequency, and a vertical axis is the output power Pout. The drooping characteristics are not limit io those sed on the VSG control, and for example, may be stored as table data inside the power conversion devices 10 and 20. More specifically, the storage circuit 301 of the first control parameter management unit 11 or the storage circuit of the second control parameter management unit 21 may store the drooping characteristic as the table data. Other storable devices may store the drooping characteristic as the table data.

In a case where both the inverter power sources 15 and 25 perform the VSG control, the frequencies of both are synchronized. That is, the values of the deviation Δf in the control of the inverter power sources 15 and 25 match each other; A region where the output power Pout is positive (above the origin O) shows a case here the distributed power sources 14 and 24 discharge. A region where the output power Pout is negative (below the origin O) shows a case where the distributed power sources 14 and 24 are charged. The inverter power sources 15 and 25 are required to be used such that the output power Pout is in a range between a predetermined lower limit value and a predetermined upper limit value. The upper limit value and the lower limit value may be set differently between the first inverter power source 15 and the second inverter power source 25.

The term “rated capacity Pmax” in FIG. 12 is an example of the “upper limit value” and is the maximum allowable power that the inverter power sources 15 and 25 can output. In other words, Pmax is a rated capacity of the inverter power sources 15 and 25 on a discharge side. The term “rated capacity Pmin” in FIG. 13 is an example of the “lower limit value” and is the maximum allowable power that can be charged to the inverter power sources 15 and 25. In other words, Prin is a rated capacity of the inverter power sources 15 and 25 on a charge side. The discharge-side rated capacity Pmax and the charge-side rated capacity Pmin are determined based on, for example, the amount of heat generated during charging and discharging.

However, the “upper limit value” is not limited to the rated capacity Pmax and may be a value set by the power management device 2 as the maximum value of the output power Pout of the inverter power sources 15 and 25. Similarly, the “lower limit value” is not limited to the rated capacity Pmin and may be a value set by the power management device 2 as the minimum value of the output power Pout of the inverter power sources 15 and 25. In the following, a case where the first inverter power source 15 and the second inverter power source 25 have an identical rated capacity Pmax and an identical rated capacity Pmin will be described. However, the first inverter power source 15 and the second inverter power source 25 may have different rated capacities Pmax, or may have different rated capacities Prin.

The deviation Δf is a difference in frequency of the alternating current power of the actual power system with respect to the frequency command value Fref*. The smaller Δf indicates that the actual frequency is lower than the frequency command value Fref*, that is, the load on the power system is increased. Therefore, the smaller the Δf, the more power needs to be supplied from the distributed power sources 14 and 24. On the contrary, the larger Δf indicates that the load in the power system decreases (the surplus power is lar Therefore, the larger the Δf, the distributed power sources 14 and 24 can be charged using larger power. The a abo-described Δfmin is the value of the deviation Δf in a case where both the first output power Pout I and the second output power Pout2 match the upper limit value (the rated capacity Pmax in the example of FIG. 12). The above-described Δfmax is the value of the deviation Δf in a case where both the first output power Pout1 and the second output power Pout2 match the lower limit value (the rated capacity Pmin in the example of FIG. 13).

In the present embodiment, in a case where the inverter power source 15 is controlled according to the original drooping characteristics, and in a case where the output of the inverter power source 15 exceeds Pmax (or Pmin), control is performed to add an offset to the power command value Pref* output by the power management device 2. In FIG. 12, a straight line L1 indicates the original drooping characteristic of the first inverter power source 15. The “original drooping characteristic” is a drooping characteristic in a case where the first power command value Pref1* output by the power management device 2 is used as it is. On the other hand, a straight line L1′ is a drooping characteristic after the first Pref control unit 12a adds an offset to the first power command value Pref1*. A straight line L2 is an original drooping characteristic of the second inverter power source 25. In the present embodiment, the first inverter power source 15 performs the Pref control until the deviation of the frequency of the alternating current system voltage output by the second inverter power source 25 matches Δfmin. In other words, the first inverter power source 15 executes the Pref control until Pref1″ matches Pref2*.

An intercept of the straight line L1 is the first power command value Pref1*. An intercept of the straight line L2 is the second power command value Pref2 The inclinations of the straight lines L1 and 12 are determined by the damping coefficient Dg, the governor gain Kdg, and the like in the VSG control. The examples of FIGS. 12 and 13 represent a case where the control parameters (the damping coefficient Dg and the governor gain Kdg in the present embodiment) in a case of performing the VSO control are the same for the first inverter power source 15 and the second inverter power source 25. Therefore, the inclinations of the straight lines L1 and L2 are the same. However, the control parameters may be different between the first inverter power source 15 and the second invert power source 25. That is, the inclinations of the straight line L1 and the straight line L2 may be different from each other. The example of FIG. 12 shows a case where the first power command value Pref1* is greater than the second power command value Pref2*.

First, a case where the inverter power sources 15 and 25 discharge will be described. In FIG. 12, a case where the load of the power system increases and first Δf decreases from 0 to α2 is considered. In a case where 0α1<Δf<0, the values (output power Pout) on the vertical axis for both the straight lines L1 and L2 are less than the rated capacity Prax. Therefore, both the first inverter power source 15 and the second inverter power source 25 can perform a discharge operation properly. In a case where Δf=α1, the value on the vertical axis of the straight line L2 is less than the rated capacity Pmax, but the value on the vertical axis of the straight line L1 matches the rated capacity Pmax. Here, in a case where the drooping characteristic of the first inverter power source 15 is maintained in the straight line L1, the value on the vertical axis of the straight line L1 exceeds the rated capacity Pmax in a range of Δf<α1. In this case, the first inverter power source 15 cannot decrease the frequency any further. On the other hand, the second inverter power source 25 increases the output power and decreases the frequency. As a result, the first inverter power source 15 and the second inverter power source 25 become unable to maintain frequency synchronization, and a phase difference between the alternating current voltages output by the first inverter power source 15 and the second inverter power source 25 increases. As a result, the cross current power between the inverter power sources 15 and 25 increases, which exceeds the allowable power of both inverter power sour Therefore, the operation of both inverter power sources 15 and 25 may be stopped by the operation of the protective circuit or the like.

Therefore, in the present embodiment, the power conversion device 10 autonomously changes the dropping characteristics of the inverter power source 15 such that the output power Pout does not exceed the upper limit value (the rated capacity Pmax in the case of FIG. 12). The change in the drooping characteristics is performed by the inverter control unit 12 (for example, the Pref control unit 12a) based on the detected value Pmeasure and the power command value Pref*. The “change in drooping characteristics” includes a case of changing the intercept and a case of changing the inclination. The straight line L1′ in FIG. 12 shows a case where the intercept of the straight line L1 is changed, Specifically, the intercept of the straight line L1′ is the first change command value Pref1′.

Next, a case where the load of the power system further increases and Δf decreases from α2 to ΔFmin is considered. Pload=2*Pmax is assumed. Here, in a case where the drooping characteristic of the first inverter power source 15 is maintained in the straight line L1′, the value on the vertical axis of the straight line L1′ exceeds the rated capacity Pmax in a range of Δf<α2. In this case, the first inverter power source 15 cannot decrease the frequency any further. The power conversion device 10 autonomously changes the drooping characteristics of the inverter power source 15 such that the output power Pout does not exceed the upper limit value (the rated capacity Pmax in the case of FIG. 12) even in a range of Δf<α2. In this case, the straight line L1′ is further changed to a straight line L1″. In the example of FIG. 12, since the straight line L1″ and the straight line L2 overlap each other, the illustration of the straight line L1″ is omitted. Specifically, the intercept of the straight line L1″ is the first change command value Pref1″. In the example of FIG. 12, Pref1″=Pref2*. That is, in the example of FIG. 12, a case where the first inverter control unit 12 changes the intercept of the drooping characteristic from the original first power command value Pref1* to the first change command value Pref1′ and Pref1″ (=Pref2*) is represented.

As a result of the first inverter control unit 12 changing the drooping characteristic as in the straight line L1′, the output power Pout of the first inverter power source 15 is equal to or less than the capacity Pmax even within a range of α2<Δf<α1, That is, since it is within the range of the allowable maximum power of the first inverter power source 15, the normal operation can be continued. As described above, by changing the dropping characteristics, it is possible to widen the range in which the inverter power source 15 normally operates. In the present embodiment, in a case where the Pref command value is changed, the Pref command value is controlled to be generated such that the output power of the first inverter power source 15 is the allowable maximum power (the rated capacity Prax).

Next, a case of charging the inverter power sources 15 and 25 will be described. In FIG. 13, a case where the load of the power system decreases and first Δf increases from 0 β2 is considered. In a case where 0<Δf<β1, the values (output power Pout) on the vertical axis of both the straight lines L1 and L2 is greater than the rated capacity Pmin. Therefore, both the first inverter power source 15 and the second inverter power source 25 can perform a charging operation properly. In a case where Δf=β1, the value on the vertical axis of the straight line L1 is greater than the rated capacity Prin, but the value on the vertical axis of the straight line L2 matches the rated capacity Pmin. In this case, the second inverter power source 25 cannot further increase the frequency. As a result, the second inverter power source 25 and the first inverter power source 15 become unable to maintain frequency synchronization, and a phase difference between the alternating current voltages output from the second inverter power source 25 and the first inverter power source 15 increases. As a result, the cross current power between the inverter power sources 15 and 25 increases, which exceeds the allowable power of both inverter power sources. Therefore, the operation of both inverter power sources 15 and 25 may be stopped by the operation of the protective circuit or the like, Therefore, in the present embodiment, the drooping characteristic of the second inverter power source 25 is changed such that the output power Pout does not fall below the lower limit value (the rated capacity Pmin in the case of FIG. 13). A straight line L2′ in FIG. 13 shows a case where the intercept of the straight line L2 is changed.

Specifically, the intercept of the straight line L2′ is the second change command value Pref2′.

Next, a case where the load of the power system further decreases and Δf increases from β2 to ΔFmax is considered. It is assumed that Pload=2*Pmin. Here, in a case where the drooping characteristics of the second inverter power source 25 are maintained as the straight line L2′, the value on the vertical axis of the straight line L2′ falls below the rated capacity Pmin in a range of Δf>β2. In this case, the second inverter power source 25 cannot further increase the frequency. The power conversion device 10 autonomously changes the drooping characteristics of the inverter power source 25 such that the output power Pout does not fall below the lower limit value (the rated capacity Pmin in the case of FIG. 13) even in a range of Δf>β2. In this case, the straight line L2′ is further changed to a straight line L2″. In the example of FIG. 13, since the straight line L2″ and the straight line LI overlap each other, the illustration of the straight line L2″ is omitted. Specifically, the intercept of the straight line L2″ is the second change command value Pref2″. In the example of FIG. 12, Pref2″=Pref1*.

That is, in the example of FIG. 13, a case where the second inverter control unit 22 changes the intercept of the drooping characteristic from the original second power command value Pref2* to the second change command value Pref2′ and Pref2″ (=Pref1*) is represented.

As a result of changing the dropping characteristics by the second inverter control unit 22, the output power Pout of the second inverter power source 25 is equal to or greater than the rated capacity Pmin even in a range of β1<Δf<β2, That is, since it is within the range of the allowable maximum power of the second inverter power source 25, the normal operation can be continued. As described above, by changing the drooping characteristics, it is possible to widen the range in which the inverter power source 25 normally operates. In the present embodiment, in a case where the Pref command value is changed, the Pref command value is controlled to be generated such that the charging power of the second inverter power source 25 is the allowable maximum power (the rated capacity Pmin).

The first inverter control unit 12 may change the inclination of the drooping characteristic of the first inverter power source 15 by changing the damping coefficient Dg or the governor gain Kdg. The first inverter control unit 12 may change both the intercept and the inclination of the drooping characteristics of the first inverter power source 15. Similarly, the second inverter control unit 22 may change the inclination of the drooping characteristic of the second inverter p er source 25 by changing the damping coefficient Dg or the governor gain Kdg. The second inverter control unit 22 may change both the intercept and the inclination of the drooping characteristic of the second inverter power source 25.

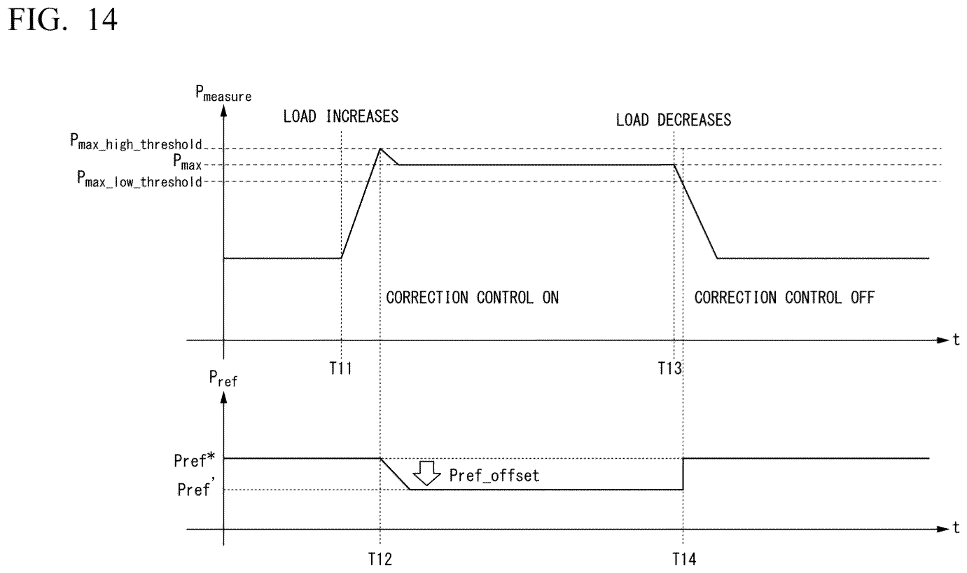

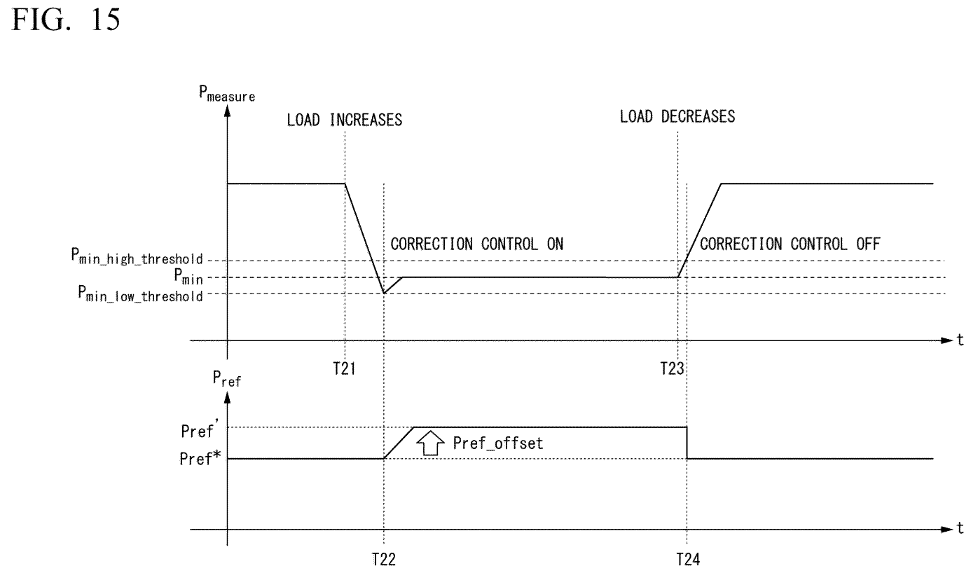

Next, examples of operations of the power conversion devices 10 and 20 will be described with reference to FIGS. 14 and 15, FIG. 14 shows an operation in a case where the load increases and the detected value Pmeasure exceeds the “upper limit value” described above, FIG. 15 shows an operation in a case where the load decreases and the detected value Pmeasure falls below the “lower limit value” described above. The operations of FIGS. 14 and 15 may be performed by either the power conversion device 10 or the power conversion device 20.

The horizontal axis of FIGS. 14 and 15 is time. The vertical axis of the upper graphs in FIGS. 14 and 15 is the detected value Pmeasure. The vertical axis of the lower graphs in FIGS, 14 and 15 is the target output Pref. Pmax in FIG. 14 is the discharge-side rated capacity described above (an example of the “upper limit value”). Pmax_high_threshold in FIG. 14 is an upper limit-side high-level threshold value, and is used to determine whether or not to turn on the Pref (correction) control in a case where the load increases. The term “correction control” is to change the drooping characteristic (power command value: Pref), Pmax_low_threshold in FIG. 14 is an upper limit-side low-level threshold value, and is used to determine whether or not to turn off the Pref (correction) in a case where the load decreases during the operation in a Pref control mode (details will be described later). The Pmax_high_threshold is set to a higher value than the upper limit value, and the Pmax_low_threshold is set to a lower value than the upper limit value.

Pmin in FIG. 15 is the charge-side rated capacity (an example of a “lower limit value”) described above. Pmin_high_threshold in FIG. 15 is a lower limit-side high-level threshold value, and is used to determine whether or not to turn on Pref (correction) control in a case where the load decreases. Pmin_low_threshold in FIG. 15 is a lower limit-side low-level threshold value, and is used to determine whether or not to turn off the Pref (correction) control in a case where the load increases. Pmin_high_threshold is set to a higher value than the lower limit value, and Pmin_low_threshold is set to a lower value than the lower limit value. The Pmax_high_threshold, the Pmax_low_threshold. the Pmin_high_threshold, and the Pmin_low_threshold may be values that are set by the power management device 2 and notified to the power conversion devices 10 and 20 thereby. Alternatively, Pmax_high_threshold, Pmax_low_threshold, Pmin_high_threshold, and Pmin_low_threshold may be values that are autonomously ser. by the power conversion devices 10 and 20.

At T11 in FIG. 14, the detected value Pmeasure is stable, and the Pref (correction) control is turned off. That is, the power command value Pref is used as it is as the target output Pref. At t=T11 in FIG. 14, the detected value Pmeasure increases in accordance with an increase in the load. At t=T12, the detected value sure exceeds the rated capacity Pmax and reaches Pmax_high_threshold. In this case, the Pref (correction) control is turned on, and the target output Pref is changed to the change command value Pref. Specifically, Pref*=Pref*+Pref_offset. The Pref_offset is an offset amount to be applied to the power command value Pref* and is a negative value in the example of FIG. 14. As a result of the Pref (correction) control being turned on and the target output Pref being decreased, the detected value Pmeasure also decreases to the rated capacity Pmax.

At t=T13, the detected value Pmeasure decreases in accordance with the decrease in the load. At t=T14, and the detected value Pmeasure decreases to Pmax_low_threshold. In this case, the Pref (correction) control is turned off, and the target output Pref returns to the power command value Pref*. That is, the offset amount Pref_offset is set to zero, and the target output Pref is determined based on the original drooping characteristic. In this way, the ON/OFF of the Pref (correction) control is switched based on the comparison between the detected value Pmeasure and the Pmax_high_threshold and the Pmax_Jow_threshold. However, the ON/OFF of the Pref (correction) control may be switched based on the comparison between the detected value Pmeasure and the upper limit value (for example, the rated capacity Pmax) without using Pmax_high_threshold and Pmax_low_threshold.

At t<T21 in FIG. 15, the detected value Pmeasure is stable, and the Pref (correction) control is turned off. That is, the power command value Pref* is used as it is as the target output Pref. At t=T21 in FIG. 15, the detected value Pmeasure decreases in accordance with the decrease in the load. At t=T22, the detected value Pmeasure falls below the rated capacity Pmin and reaches Pmin_low_threshold. In this case, the Pref (correction) control is turned on, and the target output Pref is changed to the change command value Pref. Specifically, Pref*=Pref*+Pre_offset. The offset amount Pref_offset in the example of FIG. 15 is a positive value. As a result of the Pref (correction) control being turned on and the target output Pref being increased, the detected value Pmeasure also increases to the rated capacity Potin.

At t=T23, the detected value Pmeasure increase in accordance with an increase in the load. At t=T24, the detected value Pmeasure increases to Pmin_high_threshold. In this case, the Pref (correction) control is turned off, and the target output Pref returns to the power command value Pref*. That is, the offset amount Pref_offset is set to zero, and the target output Pref is determined based on the original drooping characteristic.

In this way, the ON/OFF of the Pref (correction) control is switched based on the comparison between the detected value Pmeasure and the Pmin_high_threshold and the Pmin_low_threshold. However, the ON/OFF of the Pref (correction) control may be switched based on the comparison between the detected value Pmeasure and the lower limit value (for example, the rated capacity Pinin) without using Pmax_low_threshold and Pmax_low_threshold. In the present embodiment, as described above, hysteresis is applied to the ON/OFF of the Pref (correction) control, so that hunting of the ON/OFF of the Pref (correction) control is prevented. However, the present disclosure is not limited thereto, and it is needless to say that hysteresis is not particularly provided or a dead zone is provided for ON/OFF.

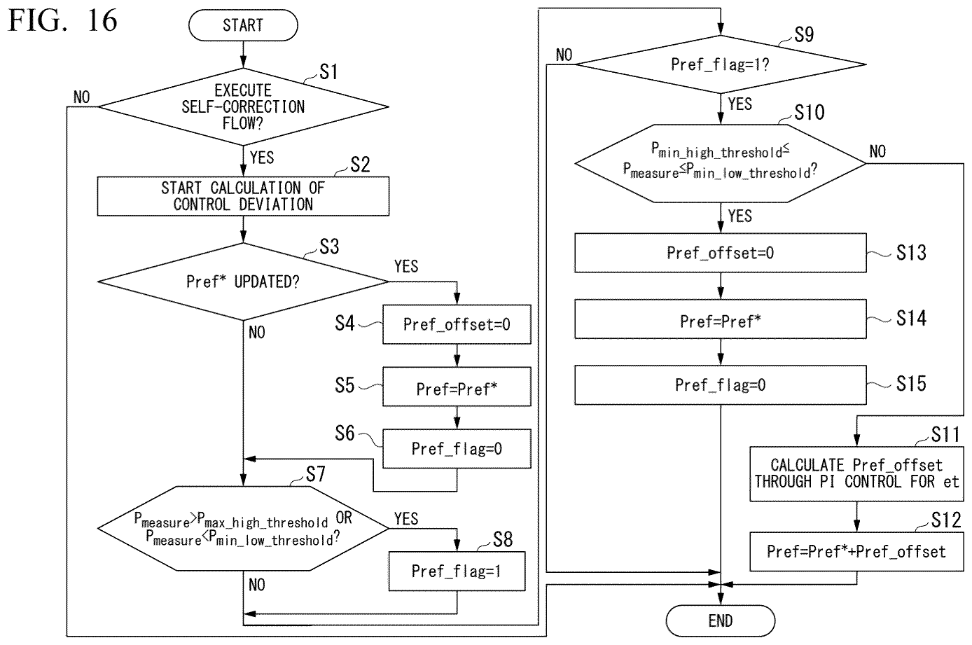

Next, an example of the control flow performed in the power conversion devices 10 and 20 will be described with reference to a flowchart of FIG. 16. The determination processing and the execution processing included in the following flow are executed by, for example, the inverter control units 12 and 22. First, in Step SI, it is determined whether or not to perform a self-correction flow. Specifically, the Pref control management unit 602 shown in FIG. 10 confirms the self-correction control flag input from the receiving unit 603. In a case where self-correction control flag is set, the Pref control management unit 602 deter nines that the self-correction flow is to be executed (S1: YES), and the processing proceeds to Step S2. In a case where the self-correction control flag is not set, the Pref control management unit 602 determines that the self-correction flow is not to be executed (S1: NO), and the processing ends. In Step S2, a control deviation et is calculated. The control deviation et will be described later.

In Step S3, the Pref control management unit 602 determines whether or not the power command value Pref* is updated compared to the previous value. This determination is performed based on whether or not an EMS change flag is set, for example. In a case where the power command value Pref* is updated (S3: YES), the processing proceeds to Step S4. In a case where the power command value Pref is not updated (S3: NO), the processing proceeds to Step S7. In Step S4, the Pref control management unit 602 outputs a reset flag to the PI control unit 601 (see FIG. 10).

Accordingly, the offset amount Pref_offset is set to zero. In Step S5, the target output. Pref is set to the power command value Pref*. In Step S6, the flag value Pref_flag is set to zero. The flag value Pref_flag is a set value related to the presence or absence of the change in the dropping characteristic. In a case where Pre_flag=0, the drooping characteristic is not changed, and the original dropping characteristic is used. This state is referred to as a “normal control mode”. In a case where Pref_flag=1, the drooping characteristic is changed. Specifically, at least either one of the intercept and the inclination is changed (in the present embodiment, the intercept of the drooping characteristic is changed). This state is referred to as a “Pref control mode”.

In Step S7, the Pref control management unit 602 determines whether or not to transition to the Pref control mode. Specifically, the Pref control management unit 602 performs comparison between the detected value Pressure and Pmax_high_threshold, and comparison between the detected value Pmeasure and Pmin_low_threshold. In a case where Pmeasure>Pmax_high_threshold or in a case where Pmeasure<Pmin_low_threshold (S7: YES), the processing proceeds to Step SS. In Step S8, the Pref_flag is set to 1, and the processing proceeds to Step S9. In a case where NO is determined in S7, the processing proceeds to Step S9 while the value of Pref_flag is maintained, In Step S9, in a case where it is determined that the value of Pref_flag is 0 (Step S9: NO), the processing ends. In Step S9, in a case where it is determined that the value of Pref_flag is 1 (Step S9: YES), the processing proceeds to Step S10.

In Step S10, the Pref control management unit 602 determines whether or not to continue the Pref control mode, Specifically, the Pref control management unit 602 performs comparison between the detected value Pmeasure and Pmin_high_threshold, and comparison between the detected value Pleasure and Pmax_low_threshold. In a case where Pmin_high_threshold≤Pmeasure≤Pmax_low_threshold is satisfied (S10: YES), the processing proceeds to Step S13. In a case where No is determined in S10, the processing proc eds to Step S11. In Step S11, the Pref control management unit 602 outputs the control deviation et to the PI control unit 601 (see FIG. 10). The PI control unit 601 performs PI control and calculates an offset amount Pref_offset such that the control deviation et is zero.

In Step S12, the addition unit 606 (see FIG. 10) adds the offset amount Pref_offset to the power command value Pref, and outputs the result to the VSG control unit 401 as the target output Pref (see FIG. 7). In a case where Step S12 is completed, the processing ends In Step S13, the offset amount Pref_offset is set to zero. In Step S14, the target output Pref is set to the power command value Pref*. In Step S15, the value of Pref_flag is set to 0, the transition is made from the Pref control mode to the normal control mode, and the processing ends,

Next, a calculation flow of the control deviation et (Step S2 in FIG. 16) will be described with reference to FIG. 17. In Step S21, a deviation between the detected value Pmeasure and the upper limit value (for example, the rated capacity Pmax) is calculated as a positive-side deviation etplus. This calculation is executed by the positive-side subtraction unit 604 shown in FIG. 10. The execution result is input to the Pref control management unit 602. In Step S22, the Pref control management unit 602 determines whether or not the positive side deviation etplus is greater than 0. In a case where etplus>0 (Step S22: YES), the processing proceeds to Step S24. In a case where etplus≤0, the value of etplus is set to zero in Step S23, and the processing proceeds to Step S24. In Step S24, a deviation between the detected value Pmeasure and the lower limit value (for example, the rated capacity Pmin) is calculated as a negative-side deviation etminus. This calculation is executed by the negative-side subtraction unit 605 shown in FIG. 10. The execution result is input to the Pref control management unit 602.

In Step S25, the Pref control management unit 602 determines whether or not the negative-side deviation etminus is less than 0. In a case where etminus<0 (S25: YES). the processing proceeds to Step S27. In a case where etminus>0 (S25: NO), the value of etminus is set to zero in Step S26, and the processing proceeds to Step S27. In Step S27, the sum of the positive-side deviation etplus and the negative deviation etminus is set as the value of the control deviation et. After that, the processing continues to Step S3 shown in FIG. 16. By executing the control flow shown in FIGS. 16 and 17, the operations shown in FIGS. 14 and 15 can be realized.

In the control flow described above, in a case of determining whether or not to perform transition between the Pref control mode and the normal control mode in Step S7 and Step S10, Pmax_high_threshold, Pmin_low_threshold, Pmax_low_threshold, and Pmin_high_threshold are used. Accordingly, it is possible to avoid the occurrence of so-called hunting. The hunting is a phenomenon in which the transition between the modes is repeatedly executed in a case where the value of the Pref_offset is near zero, In a case where the hunting can be avoided, condition settings of Pmax_high_threshold, Pmin_low_threshold. Pmax_low_threshold, and Pmin_high_threshold can be changed.

The functions of the power management device 2 and the power conversion devices 10 and 20 described above are realized by a processor such as a central processing unit (CPU) executing a program stored in a program memory, for example. Some or all of these functions may be realized by hardware such as large scale integration (LSD), application specific integrated circuit (ASIC), or field-programmable gate array (FPGA), or may be realized by cooperation of software and hardware.

The program for realizing the functions of the power mar vi d the power conversion devices 10 and 20 described above is record computer-readable recording medium, for example. Then, by causing a computer to read and execute the program recorded on this recording medium, the processing in the power management device 2 and power conversion devices 10 and 20 described above may be performed. Here, “causing a computer to read and execute the program recorded on this recording medium” includes installing the program in the computer. The term “computer” mentioned here includes an OS and hardware such as peripheral devices.

In addition, the “computer” may include a plurality of computer devices connected through a network including a communication line such as the Internet, a WAN, a LAN, and a dedicated line. In addition, the term “computer-readable recording medium” refers to a storage device, for example, a portable medium such as a flexible disk, a magneto-optical disk, a ROM, or a CD-ROM, and a hard disk built in a computer. In this way, the recording medium on which the program is stored may be a non-transitory recording medium such as a CD-ROM.

Furthermore, the recording medium also includes an internal or external recording medium that is accessible by a distribution server for distributing the program. The program may be divided into a plurality of parts, and the parts may be downloaded at different timings and then be combined in the power management device 2 or the power conversion devices 10 and 20. Furthermore, the divided programs may be distributed by different distribution servers. Furthermore, the term “computer-readable recording medium” includes a medium that holds the program for a certain period of time, such as a volatile memory (RAM) inside the computer that as a server or a client in a case where the program is transmitted through a network. In addition, the program described above may be a program for realizing some of the functions described above. Furthermore, the program described above may be a so-called difference file (difference program). The difference program realizes the functions described above in combination with a program already recorded in the computer.

As described above, the power conversion device 10 according to the present disclosure supplies alternating current power to the power system as a voltage source, based on the power command value Pref generated by the power management device 2. The power conversion device 10 includes the inverter 13 that converts direct current power of the distributed power source 14 into alternating current power, the control parameter management unit 11 that manages a control parameter of the inverter 13, the detection unit 16 that detects output power Pout of the inverter 13 and that outputs the detected power as a detected value Pmeasure, and the inverter control unit 12, The inverter control unit 12 generates voltage command values (u*, v*, w*) for controlling the inverter 13, based on the detected value Pmeasure, the power command value Pref, and the control parameters (damping coefficient Dg, inertia constant M, governor gain Kdg, governor time constant T, and the like) output from the control parameter management unit 11. The control parameter is related to a drooping characteristic that is a correlation between the output power Pout of the inverter 13 and the frequency. The inverter control unit 12 changes the drooping characteristic based on the detected value Pmeasure and the power command value Pref*, and generates the voltage command values (u*, v*, w*) Das on the changed drooping characteristic.

According to this configuration, in a case where a load fluctuation occurs in the power system, it is possible to prevent the output power Pour of the distributed power source 14 from exceeding the upper limit value or falling below the lower limit value. Therefore, it is possible to prevent the operation of the distributed power source 14 from being stopped.

In addition, the inverter control unit 12 may offset the drooping characteristic by adding the offset amount Pref_offset to the power command value Pref*. That is, the inclination of the drooping characteristic may be maintained, and only the intercept thereof may be changed.

In addition, in a case where the detected value Pmeasure is within a range from the upper limit value to the lower limit value, the inverter control unit 12 may generate the voltage command values (u*, v*, w*) based on the drooping characteristics used without adding the offset amount Pref_offset to the power command value Pref*, and in a case where the detected value Pmeasure exceeds the upper limit value, the inverter control unit 12 may generate the voltage command values (u*, v*, w*) based on the drooping characteristics used by adding the offset amount Pref_offset to the power command value Pref* such that the output power Pout matches the upper limit value, and in a case where the detected value Pmeasure falls below the lower limit value, the inverter control unit 12 may generate voltage command values (o*, v*, w*) based on the dropping characteristics used by adding the offset amount Pref_offset to the power command value Pref* such that the output power Pout matches the lower limit value.

In addition, in a case where the power command value Pref* is updated, the inverter control unit 12 may set the offset amount Pref_offset to zero and generate the voltage command values (u* v*, w*) based on the drooping characteristics using the updated power command value Pref*.

In addition, in a case where the offset amount Pref_offset is added to the power command value Pref* and the detected value Pmeasure falls below an upper limit-side low-level threshold value Pmax_low_threshold or a case when the offset amount Pref_offset is added to the power command value Pref* and the detected value Pmeasure exceeds a lower limit-side high-level threshold value Pmin_high_threshold, the inverter control unit 12 may set the offset amount Pref_offset to zero.

In addition, the upper limit-side low-level threshold value Pmax_low_threshold and the lower limit-side high-level threshold value Pmin_high_threshold may be notified from the power management device 2.

In addition, in a case where the offset amount Pref_offset is added to the power command value Pref* and the detected value Pmeasure falls below the upper limit value or a case where the offset amount Pref_offset is added to the power command value Pref* and the detected value Pmeasure exceeds the lower limit value, the inverter control unit 12 may set the offset amount Pref_offset to zero.

Furthermore, the inverter control unit 12 may calculate the offset amount Pref_offset based on PI control.

Furthermore, the inverter control unit 12 may perform virtual synchronous generator control.

In addition, a power conversion method according to the present embodiment includes a step of detecting output power Pout of the inverter 13 as a detected value Pmeasure, a step of changing a drooping characteristic that is a correlation between the output power Pout of the inverter 13 and the frequency, based on the power command value Pref* generated by the power 2 and the detected value Pmeasure, a step of generating voltage command values (u*, v*, w*) based on the changed drooping characteristic, and a step of converting the direct current power of the distributed power source 14 into alternating current power based on the voltage command values (u*, v*, w*).

In addition, a power conversion program according to the present embodiment causes a computer to exe processing of changing a drooping characteristic, which is a correlation between the output power Pout in the inverter 13 and the frequency, based on the power command value Pref* generated by the power management device 2 and the detected value Pmeasure of the output power Pout of the inverter 13, processing of generating the voltage command values (u*, v*, w*) based on the changed dropping characteristic, and processing of converting the direct current power of the distributed power source 14 into the alternating current power based on the voltage command values

The technical scope of the present disclosure is not limited to the embodiment described above, and various modifications can be made within the scope of the present disclosure,

For example, in the embodiment described above, a case where the power conversion devices 10 and 20 perform the VSG control has been described as an example. However, either one or both of the power conversion devices 10 and 20 may not perform the VSG control. Even in a case where the VSG control is not performed, it is possible to avoid the output power from exceeding the upper limit value thereof by changing the drooping characteristics as described in the embodiment described above.

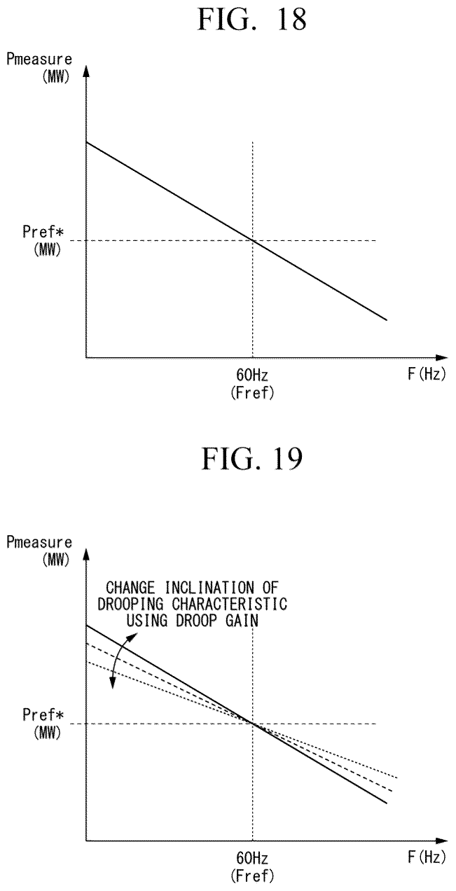

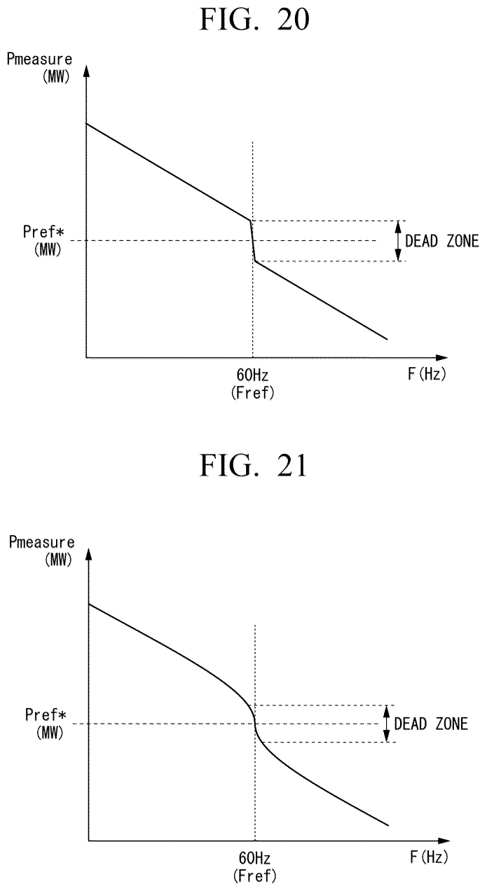

A specific example of control in a case where the first power conversion device 10 or the second power conversion dev e 20 does not perform the VSG control will be described with reference to FIGS. 18 to 21. FIGS. 18 to 21 show examples of so-called droop control. In the present specification, the term “droop control” is control of changing the frequency F of the alternating current voltage in the output power Pout based on a difference between the power command value Pref* and the detected value Pleasure, More specifically, the frequency F is monotonically decreased according to the difference, In FIGS. 18 to 21, a horizontal axis is a frequency of the alternating current voltage in the output power Pout, and a vertical axis is Pmeasure. As the value of the vertical axis is farther from the power command value Pref, the difference between the power command value Pref* and the detected value Pmeasure is larger. In each of the examples in FIGS. 18 to 21, the frequency F monotonically decreases according to the difference.

FIG. 18 is an example of a drooping characteristic in a typical droop control. In FIG. 18, the frequency F is changed to be proportional to the difference between the power command value Pref* and the detected value Pmeasure, In FIG. 19, the droop gain is multiplied by the basic drooping characteristic (solid line) to change the inclination of the drooping characteristic. In FIG. 20, a dead zone is provided in a region where the value of the vertical axis is near the power command value Pref*. In the dead zone, the change in the frequency Fis small in a case where the difference between the power command value Pref-and the detected value Pmeasure is changed, compared to other regions.

By providing the dead zone, the following effects can be obtained. In a case where the power consumption of the load and the output power Pout of the power conversion devices 10 and 20 are balanced, unnecessary charging and discharging may be performed due to a sensor error of a voltmeter and an ammeter. Unnecessary charging and discharging leads to power loss and damage to the storage battery (distributed power sources 14 and 24). By providing the dead zone, it is possible to prevent such unnecessary charging and discharging and to avoid power loss and damage to the storage battery. Such an effect can be obtained even in a case where the drooping. characteristic is represented by a curve as shown in FIG. 20.

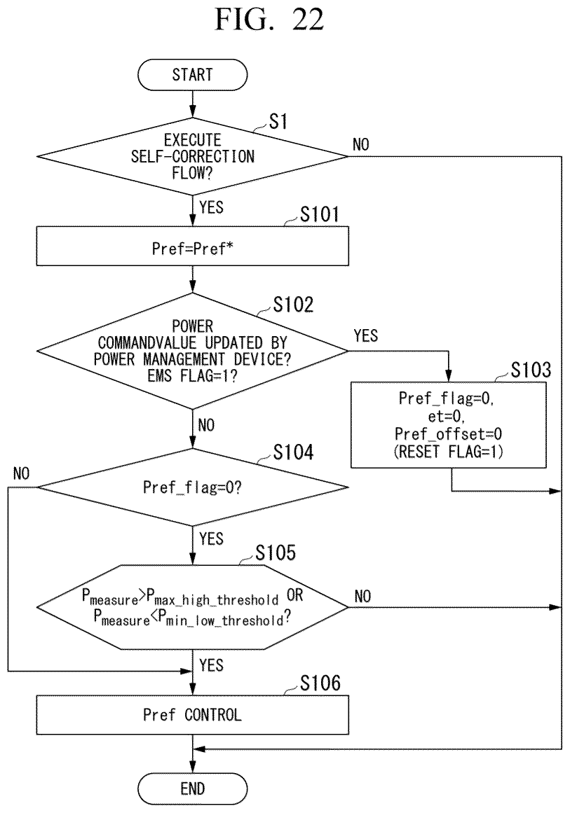

Next, an example of the Pref control flow performed in the power conversion devices 10 and 20 will be described with reference to flowcharts of FIGS. 22 to 24. The determination processing and the execution processing included in the following flow are executed by the inverter control units 12 and 22, for example. First, in Step S1, it is determined whether or not to perform the self-correction flow. Specifically, the Pref control management unit 602 shown in FIG. 10 confirms the self-correction control flag input from the receiving unit 603. In a case where the self-correction control flag is set, the Pref control management unit 602 determines that the self-correction flow is to be executed (S1: YES), and the processing proceeds to Step S101, In a case where the self-correction control flag is not set, the Pref control management unit 602 determines that the self-correction flow is not to be executed (S1: NO), and the processing ends. Io Step S101, the Pref control management unit 602 substitutes Pref* received from the power management device 2 and managed by the Pref control parameter management unit 302 in the first control parameter management unit 11 (or the second control parameter management unit 21) as a value of Pref. In a case where Step S101 ends, the Pref control 602 confirms whether or power command value (Pref*) is received from the power management device 2 in Step S102. More specifically, the Pref control management unit 602 confirms whether or not the EMS flag is set.

In a case where Yes is determined in Step S102, in Step S103, Pref_flag is cleared, and the values of et and Pref_offset are set to “zero”, In addition, the reset flag is set to “1”. Accordingly, the transition to the normal control mode is performed, and the flow ends. On the other hand, in a case where No is determined in Step S102, it is confirmed in Step S104 whether or not Pref_flag is zero, that is, whether or not the Pref control mode is being executed. In a case where Yes is determined in Step S104, it is determined whether or not to transition to the Pref control mode in Step S105. Specifically, it is determined to transition to the Pref control mode in a case where Pmeasure>Pmax_high_threshold or Pmeasure<Pmin_low_Threshold. In a case where No is determined in Step S105, the flow ends. On the other hand, in a case where Yes is determined in Step S105 or No is determined in Step S104 (in a case where the Pref control mode is being executed), the Pref control is executed in Step S106.

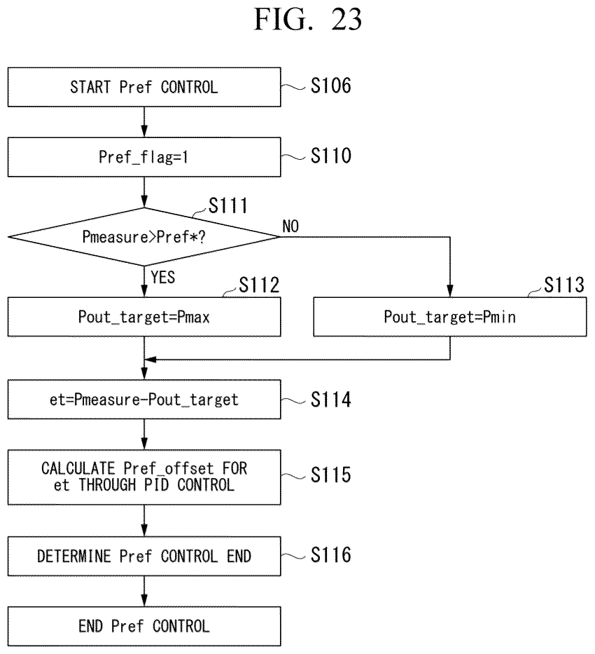

Next, a flow of the Pref control (corresponding to Step S106 in FIG. 22) will be described with reference to FIG. 23. In a case where the Pref control is started, the Pref control management unit 602 sets the Pref_flag in Step S110, and determines io Step S111 whether or not the actual measurement power (Pmeasure) is greater than the power command value (Pref*). In a case where Yes is determined in Step S111, Pmax is set as the value of the Pout_target in Step S112. On the other hand, in a case where No is determined in Step 511, Pinin is set as the value of the Pout_target in Step S113.

In a case where the setting of the Pout_target is completed in Step S112 or Step S113, the Pref control management unit 602 calculates et (=Pmeasure−Pout_target) in Step S114. In a case where Step S114 is completed, the Pref control management unit 602 performs the PID control on the calculated et to calculate Pref_offset. Although the PID control is used in the flow shown in FIG. 23, the present disclosure is not limited thereto, and it is needless to say that the PI control may be used as in FIG. 16 or the proportional control may be used. In addition, it is needless to say that the PID control or the proportional control may be used instead of the PI control in the flow (Step S11) shown in FIG. 16.

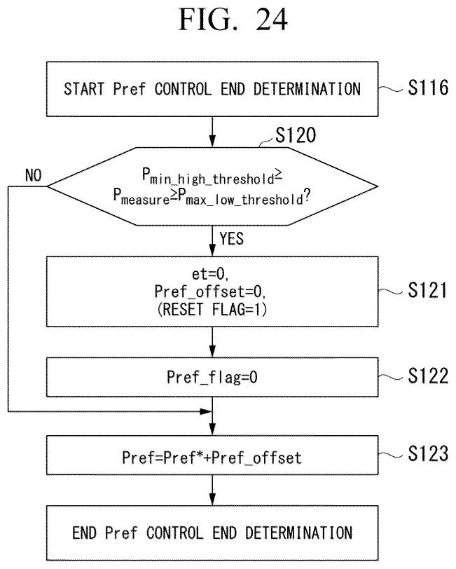

As shown in FIG. 23, in a case where Step S115 ends, the Pref control management unit 602 performs Pref control end determination in Step S116. FIG. 24 shows a Pref control and determination flow. In a case where the Pref control end determination flow is started, the Pref control management unit 602 confirms whether Pmin_high_threshold≥Pmeasure≥Pmax_low_threshold in Step S120. In a case where No is determined in Step S120, the Pref control is continued, Pref (=Pref*+Pref_offset) is calculated in Step S123, and the entire flow ends.

On the other hand, in a case where Yes is determined in Step S120, the Pref control management unit 602 determines to end the Pref control, and sets et and Pref_offset to “zero” in Step S121. In addition, the reset flag is set to “1”, and the Pref_flag is cleared in Step S122. Accordingly, the transition to the normal control mode is made, Pref (=Pref*+Pref_offset) is calculated in Step S123, and the entire flow ends.

According to the flow shown in FIGS. 22 to 24, since the drooping characteristics (Pref) of each inverter can be optimally controlled, in a case where the load fluctuation occurs in the power system, it is possible to prevent the output power Pout of the distributed power source 14 from exceeding the upper limit value or falling below the lower limit value. Therefore, an effect of preventing the operation of the distributed power source 14 from being stopped is obtained.

The flow related to the Pref control is not limited to those shown in FIGS. 16, 17, and 22 to 24, and it is needless to say that the same effect is achieved by controlling the Pref as shown in FIG. 12 or FIG. 13 described above. In addition, the number of distributed power sources having the drooping characteristics is not limited to two, and even in a case where the number of distributed pow er sources is three or more, it is less to say that the same effect can be achieved by extracting the largest value of Δfmax from among the plurality of distributed power sources or extracting the smallest value of Δfmin from among the plurality of distributed power sources, and by performing the Pref control on the distributed power source having each drooping characteristic as described above, In addition, in the present embodiment, the case where the capacities of the distributed power sources having the drooping characteristics are the same has been described, but the present disclosure is not limited thereto. Even in a case where the capacities of the distributed power sources are different, for example, in a case where the discharging power becomes maximum, it is needless to say that the same effect can be obtained by performing the Pref control at the frequency up to Δfmin. Similarly, in a case where the charging power becomes maximum, it is needless to say that the same effect can be obtained by performing the Pref control at the frequency up to Δfmax.

As described above, the inverter control units 12 and 22 may generate the voltage command values (u* v*, w*), based on the drooping characteristics (FIGS. 18 to 21) in which the frequency F of the output power Pout monotonically decreases according to the difference between the power command value Pref* and the detected value Pmeasure.

In addition, the above-described embodiments or modifications may be combined as appropriate.

### REFERENCE SIGNS LIST

2 Power management dev e
3 Distribution line
10, 20 Power conversion device
11, 21 Control parameter management unit
12, 22 Inverter control unit
13, 23 Inverter
16, 26 Detection unit
14, 24 Distributed power source
Pmax_low_threshold Upper limit-side low-level threshold value
Pmin_high_threshold Lower limit-side high-level threshold value
Pout Output power
Pref* Power command value
Pref_offset Offset amount
u*, v*, w* Voltage command value

1. A power conversion device for supplying alternating current power to a power system as a voltage source based on a power command value generated by a power management device, the power conversion device comprising:
an inverter configured to convert direct current power of a distributed power source into alternating current power;
a control parameter management circuitry configured to manage a control parameter of the inverter;
a detector configured to detect output power of the inverter and to output the output power as a detected value; and
an inverter controller configured to generate a voltage command value based on the detected value, the power command value, and the control parameter, the voltage command value being used to control the inverter,
wherein the control parameter is related to a drooping characteristic that is a correlation between the output power of the inverter and a frequency, and
the inverter controller changes the drooping characteristic based on the detected value and the power command value and generates the voltage command value based on the changed drooping characteristic.

2. The power conversion device according to claim 1,
wherein the inverter controller unit offsets the drooping characteristic by adding an offset amount to the power command value.

3. The power conversion device according to claim 2,
wherein the inverter controller
generates the voltage command value based on the drooping characteristic used without adding the offset amount to the power command value in a case where the detected value is within a range from an upper limit value to a lower limit value,
generates, in a case where the detected value exceeds the upper limit value, the voltage command value based on the drooping characteristic used by adding the offset amount to the power command value such that the output power matches the upper limit value, and
generates, in a case where the detected value falls below the lower limit value, the voltage command value based on the drooping characteristic used by adding the offset amount to the power command value such that the output power matches the lower limit value.

4. The power conversion device according to claim 2, wherein in a case where the power command value is updated, the inverter controller sets the offset amount to zero and generates the voltage command value based on the drooping characteristic using the updated power command value.

5. The power conversion device according to claim 2,
wherein the inverter controller sets the offset amount to zero in a case where the offset amount is added to the power command value and the detected value falls below an upper limit-side low-level threshold value or in a case where the offset amount is added to the power command value and the detected value exceeds a lower limit-side high-level threshold value.

6. The power conversion device according to claim 5,
wherein the upper limit-side low-level threshold value and the lower limit-side high-level threshold value are notified from the power management device.

7. The power conversion device according to claim 2,
wherein the inverter controller-unit sets the offset amount to zero in a case where the offset amount is added to the power command value and the detected value falls below an upper limit value or in a case where the offset amount is added to the power command value and the detected value exceeds a lower limit value.

8. The power conversion device according to claim 2,
wherein the inverter controller calculates the offset amount based on PI control.

9. The power conversion device according to claim 1,
wherein the inverter controller generates the voltage command value based on a drooping characteristic in which a frequency of the output power monotonically decreases according to a difference between the power command value and the detected value.

10. The power conversion device according to claim 9,
wherein the inverter controller performs virtual synchronous generator control.

11. A power conversion method comprising:
detecting output power of an inverter as a detected value;
changing a drooping characteristic that is a correlation between the output power of the inverter and a frequency, based on a power command value generated by a power management device and the detected value;
generating a voltage command value based on the changed drooping characteristic; and
converting direct current power of a distributed power source into alternating current power based on the voltage command value.

12 . A non-transitory computer-readable storage medium storing a power conversion program causing a computer to execute:
changing a drooping characteristic that is a correlation between output power of an inverter and a frequency, based on a power command value generated by a power management device and a detected value of the output power of the inverter;
generating a voltage command value based on the changed drooping characteristic; and
converting direct current power of a distributed power source into alternating current power based on the voltage command value.
